(19) United States
(12) Patent Application Publication
(10) Pub. No.: US 2016/0076903 A1
(43) Pub. Date: Mar. 17, 2016

(54) User Geographic Area Familiarity Based Navigation Instructions

(71) Applicant: Microsoft Corporation, Redmond, WA (US)

(72) Inventors: Ana Lilia Otero Diaz, Woodinville, WA (US); Hae Jin Lee, Seattle, WA (US); Douglas R. Kirschner, Seattle, WA (US); Paul R. Nash, Bellevue, WA (US); Jeffrey Darren Couckuyt, Bothell, WA (US); Vishal Mishra, Sammamish, WA (US)

(21) Appl. No.: 14/485,500

(22) Filed: Sep. 12, 2014

(51) Int. Cl. G01C 21/36; G01C 21/34

(52) U.S. Cl. CPC G01C 21/3641; G01C 21/3484

(57) ABSTRACT

A familiarity that a user of a navigation device has with each of multiple geographic areas is determined. A route to a destination is identified and navigation instructions are provided to the user as he or she travels along the route. The instructions provided to the user along the route are generated based on the familiarity of the user with one or more geographic areas along the route. This generation of instructions can include delaying the start of providing instructions to the user, adapting the level of guidance provided to the user, adapting the aggressiveness of route recalculation, combinations thereof, and so forth.

### BACKGROUND

As computing technology has advanced, people have come to rely on their computing devices for various functionality. One type of functionality people rely on is navigation, such as using dedicated devices or their smartphones to receive instructions in their car to navigate to a destination. Although such functionality is very useful for users, it is not without its problems. One such problem is that the navigation functionality typically provides the same information on each of the various devices, providing detailed instructions along a route to a particular destination. This can be frustrating for some users as they can receive detailed instructions that they already know.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In accordance with one or more aspects, the familiarity of a user of a navigation device with a geographic area is determined. A route to a destination is identified, the route passing through at least part of the geographic area. Navigation instructions regarding the route based on the familiarity of the user with the geographic area are generated, including changing multiple instructions regarding part of the route to a simplified instruction that specifies a location along the route. The generated instructions are presented, the presenting including presenting the simplified instruction rather than the multiple instructions.

In accordance with one or more aspects, a navigation device includes a global navigation satellite system, implemented at least in part in hardware, configured to determine a position of the navigation device, and a familiarity determination module configured to determine a familiarity of a user of the navigation device with a geographic area. The navigation device also includes a familiarity-based route identification module configured to identify a route from the position of the navigation device to a destination, the route passing through at least part of the geographic area. The familiarity-based route identification module is further configured to generate navigation instructions regarding the route based on the familiarity of the user with the geographic area, including varying an aggressiveness of route recalculation based on the familiarity of the user with the geographic area, and present the generated instructions.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion.

FIG. 1 is a block diagram illustrating an example navigation device implementing the user geographic area familiarity based navigation instructions in accordance with one or more embodiments.

FIG. 2 is a flowchart illustrating an example process for implementing user geographic area familiarity based navigation instructions in accordance with one or more embodiments.

FIG. 3 is a flowchart illustrating an example process for generating instructions regarding a route in accordance with one or more embodiments.

FIG. 4 illustrates an example user interface presenting simplified instructions in accordance with one or more embodiments.

FIG. 5 illustrates an example user interface that can be displayed to a user of a device to allow the user to select whether position data for that device will be recorded in accordance with one or more embodiments.

FIG. 6 illustrates an example system that includes an example computing device that is representative of one or more systems and/or devices that may implement the various techniques described herein.

### DETAILED DESCRIPTION

User geographic area familiarity based navigation instructions are discussed herein. A familiarity that a user of a navigation device has with a particular geographic area is determined. A route to a particular destination is identified, and navigation instructions are provided to the user, for example as he or she travels along the route. The instructions provided to the user are advantageously generated based on the familiarity of the user with one or more geographic areas along the route. This instruction generation can include delaying the start of providing instructions to the user, adapting the level of guidance provided to the user, adapting the aggressiveness of route recalculation, combinations thereof, and so forth.

By generating the navigation instructions based on user familiarity with one or more geographic areas along the route, the navigation device advantageously improves usability of the device by, for example, adapting the instructions provided to the user based on what the user knows about the route (e.g., his or her familiarity with geographic places along the route). By generating the instructions based on user familiarity with one or more geographic areas along the route, the navigation device also advantageously increases energy savings in the device, for example, by reducing the amount of information that is displayed by the navigation device (or allowing a screen of the navigation device to be turned off), by reducing the amount of information that is played back audibly by the navigation device, and so forth.

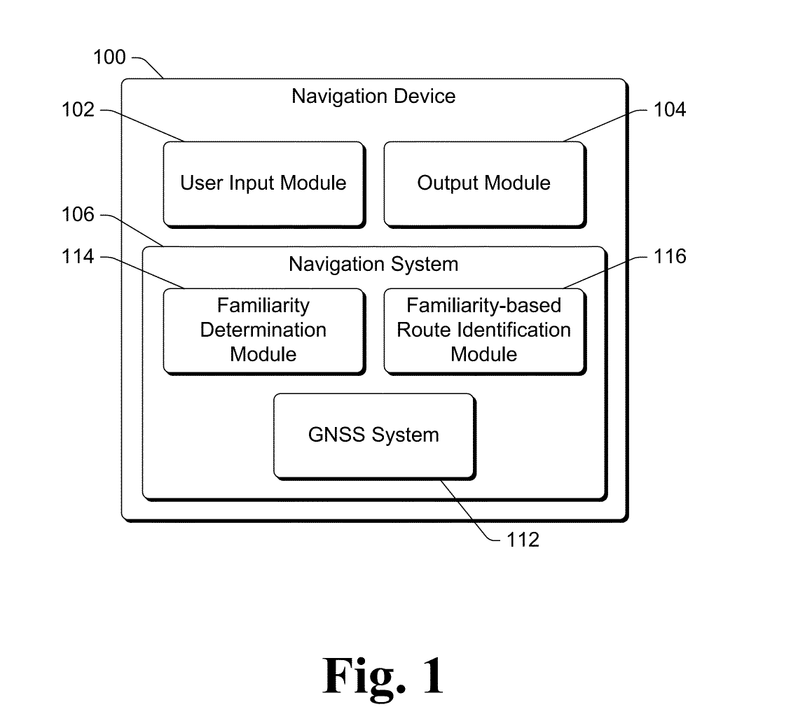

FIG. 1 is a block diagram illustrating an example navigation device 100 implementing the user geographic area familiarity based navigation instructions in accordance with one or more embodiments. Navigation device 100 can be a variety of different types of devices, such as a cellular or other wireless phone (e.g., a smartphone), a laptop or netbook computer, a tablet or notepad computer, a phablet computer, a wearable device (e.g., eyeglasses, watch), a mobile station, an entertainment appliance, a dedicated or standalone navigation device, an automotive computer, and so forth. Thus, computing device 100 may range from full resource devices with substantial memory and processor resources (e.g., laptop computers, tablet computers) to low-resource devices with limited memory and/or processing resources (e.g., dedicated or standalone navigation devices).

Computing device 100 includes a user input module 102, an output module 104, and a navigation system 106. The user input module 102 receives user inputs from a user of navigation device 100. User inputs can be provided in a variety of different manners, such as by pressing one or more keys of a keypad or keyboard of the device 100, pressing a particular portion of a touchpad or touchscreen of the device 100, making a particular gesture on a touchpad or touchscreen of the device 100, an action that can be recognized by a motion detection or other component of the device 100 (such as shaking the device 100, rotating the device 100, bending or flexing the device 100, etc.), combinations thereof, and so forth. User inputs can also be provided in other manners, such as via voice or other audible inputs to a microphone, via motions of hands or other body parts observed by an image capture device, and so forth.

The output module 104 generates, manages, and/or outputs content for display, playback, and/or other presentation. This content can be created by the output module 104 or obtained from other modules of the navigation device 100. This content can be, for example, a display or playback portion of navigation instructions to a particular destination. The content can be displayed or otherwise played back by components of the navigation device 100 (e.g., speakers, interactive display devices, etc.). Alternatively, the output module 104 can generate one or more signals that are output to other devices or components (e.g., speakers, display devices, etc.) that are separate from the navigation device 100 (e.g., speakers in a vehicle in which the navigation device 100 is situated).

The navigation system 106 includes a Global Navigation Satellite System (GNSS) system 112, a familiarity determination module 114, and a familiarity-based route identification module 116. The GNSS system 112 implements GNSS functionality for the device 100, determining a geographic position of the device 100 based on one or more satellites from which the GNSS system 112 can receive signals or otherwise communicate. This determined position is typically latitude and longitude coordinates, although the position can alternatively be specified in other manners. The GNSS system 112 can implement the GNSS functionality using a variety of different technologies, such as the Global Positioning System (GPS), the Global Navigation Satellite System (GLONASS), the BeiDou (or Compass) navigation system, the Galileo positioning system, combinations thereof, and so forth. Although illustrated as part of the navigation device 100, the GNSS system 112 can alternatively be situated at least in part separate from the navigation device 100. For example, one or more components of the GNSS system 112 can be implemented by a vehicle in which the navigation device 100 is situated.

The familiarity determination module 114 determines the familiarity that a user of the navigation device 100 has with various different geographic areas. This determination can be performed automatically, such as by analyzing the different geographic locations where the navigation device 100 is situated at various different times (e.g., as the device moves around in a vehicle or with the user).

The familiarity-based route identification module 116 identifies routes to destinations, the routes being based on the familiarity of the user of the device 100 with the geographic places through which the routes pass, and presents (e.g., audibly) navigation instructions as the user moves along the route. This identification and presentation can include delaying the start of providing navigation instructions to the user, adapting the level of guidance provided to the user, adapting the aggressiveness of route recalculation, combinations thereof, and so forth as discussed in more detail below.

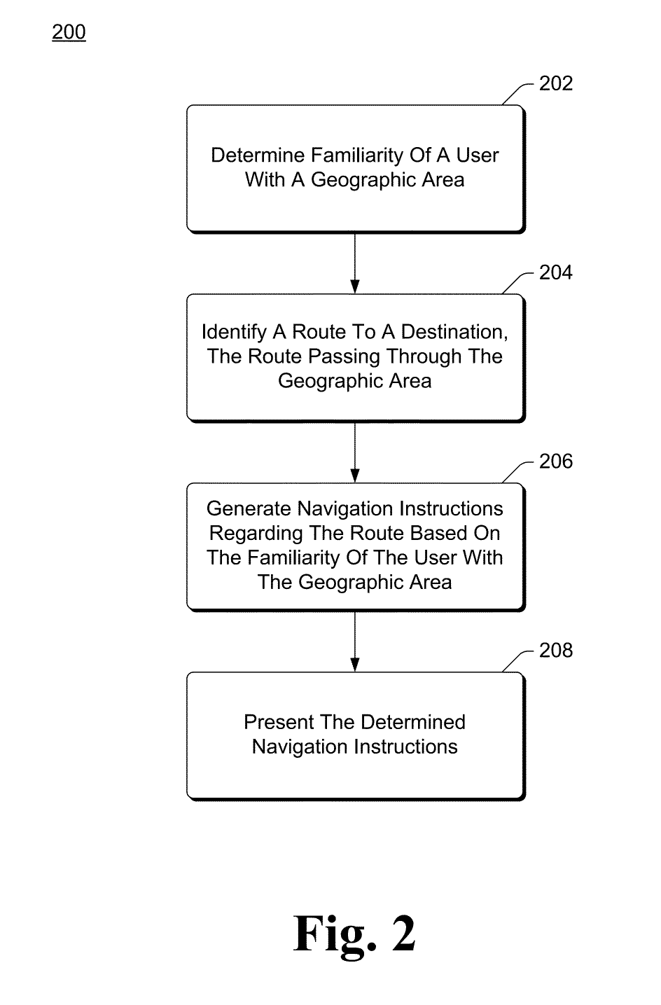

FIG. 2 is a flowchart illustrating an example process 200 for implementing user geographic area familiarity based navigation instructions in accordance with one or more embodiments. Process 200 is carried out by a device, such as navigation device 100 of FIG. 1, and can be implemented in software, firmware, hardware, or combinations thereof. Process 200 is shown as a set of acts and is not limited to the order shown for performing the operations of the various acts. Process 200 is an example process for implementing user geographic area familiarity based navigation instructions; additional discussions of implementing user geographic area familiarity based navigation instructions are included herein with reference to different figures.

In process 200, the familiarity of a user with a geographic area is determined (act 202). The familiarity of a user with a geographic area is determined by the familiarity determination module 114, which can determine the familiarity of a user with various different types of geographic areas. The different types of geographic areas refer to different granularities of areas (e.g., different sizes of areas, or differences in an amount of area included in the geographic area). For example, the different types of geographic areas may be city block, neighborhood, road, city, state, country, and so forth. These types of geographic areas are, in order of lowest granularity (smallest area) to highest granularity (largest area): city block, neighborhood, city, road, state, country. E.g., a city block bounded by four streets (e.g., 3^{rd} Ave., 2^{nd} Ave., Smith St., and McGraw St.) may be in the Queen Anne neighborhood of the city of Seattle in the state of Washington in the country of the United States. A particular road, such as Washington State Route 99 may pass through the cities of Fife, Seattle, Lynnwood, and so forth.

A different familiarity indication can be determined for each of multiple different geographic areas of each of the multiple different types of geographic areas. For example, different familiarity indications can be determined for the user for different neighborhoods, different cities, different city blocks, and so forth.

Additionally, different familiarity indications can be determined for the user for different modes of transportation. Different modes of transportation include, for example, walking, bicycling, vehicle (e.g., in a car or truck), mass transit, and so forth. Thus, different familiarity indications can be determined for each of multiple geographic areas for a walking mode of transportation, a bicycling mode of transportation, a vehicle mode of transportation, a mass transit mode of transportation, and so forth.

The familiarity indication for a geographic area is an identifier of the familiarity of the user of the navigation device 100 with that geographic area. The familiarity indication can take various different forms, such as a numerical ranking (e.g., a value between 0 and 1), a letter ranking (e.g., a value between A and F), other enumerations (e.g., one of very familiar, familiar, slightly familiar, and not familiar at all), and so forth. In some of the discussions herein, the familiarity indication is discussed as being one of very familiar, familiar, slightly familiar, and not familiar at all. It should be noted that these discussions use very familiar, familiar, slightly familiar, and not familiar at all as an example familiarity indication, and that the techniques discussed herein can be used analogously with other familiarity indications.

The familiarity determination module 114 can determine the familiarity of a user with a geographic area in a variety of different manners. In one or more embodiments, the familiarity determination module 114 receives user input specifying one or more geographic areas with which the user is familiar, such as by user selection of one or more geographic areas on a map. The user input can optionally specify how familiar the user is with each of the one or more geographic areas (e.g., using the same familiarity indication discussed above, such as a numerical ranking, letter ranking, or other enumeration). Alternatively, the user selection of a particular geographic area may be associated with a particular familiarity indication (e.g., familiar or very familiar). These user inputs can be provided in any of a variety of different manners as discussed above.

Additionally or alternatively, the familiarity determination module 114 automatically determines a user's familiarity with each of multiple geographic areas. This automatic determination of user familiarity can be made in a variety of different manners. In one or more embodiments, the geographic position of the user (assuming the user is at the same geographic position as the navigation device 100) can be identified (e.g., using the GNSS system 112 of FIG. 1) at some regular or irregular interval, and this geographic position converted to one or more geographic areas. For example, coordinates (such as latitude and longitude) of the position of the navigation device 100 at a particular time can be converted to each of different types of geographic areas (e.g., converted to a particular city block, a particular neighborhood, a particular city, and so forth). A determination can then be made of how much time a user is in each geographic area, and this amount of time can be used to determine the familiarity indication for each geographic area.

The determination of the familiarity indication for a geographic area based on how much time the user is in a geographic area can be made in a variety of different manners. For example, the number of times that the user is determined to be in a geographic area over some time interval can be divided by that time interval to obtain a numeric value between 0 and 1, with larger numerical values indicating more familiarity than smaller numeric values. E.g., if the user is determined to be in a geographic area for 15 minutes during a particular day (a 24-hour or 1440-minute interval), then the familiarity indication can be determined to be 0.0104 (15÷1440=0.0104). Or, if the user is determined to be in a geographic area for 22 hours during a particular day (e.g. a 24-hour interval), then the familiarity indication can be determined to be 0.9167 (22÷24=0.9167). Alternatively, rather than being the familiarity indication, this value (e.g., 0.0104 or 0.9167) can be used to determine the familiarity indication. E.g., if the value is less than a first threshold value (e.g., 0.001) then the familiarity indication is not familiar at all, if the value is at least the first threshold value but less than a second threshold value (e.g., 0.200) then the familiarity indication is slightly familiar, and so forth.

By way of another example, coordinates (such as latitude and longitude) of the position of the navigation device 100 at a particular time can be converted to each of different types of geographic areas (e.g., converted to a particular city block, a particular neighborhood, a particular city, and so forth). A count of how many times a user enters each geographic area over a particular time interval can be determined with larger counts indicating more familiarity than smaller counts. Alternatively, rather than being the familiarity indication, these counts can be used to determine the familiarity indication. E.g., if the value is less than a first threshold value (e.g., 1) then the familiarity indication is not familiar at all, if the value is at least the first threshold value but less than a second threshold value (e.g., 7) then the familiarity indication is slightly familiar, and so forth.

The familiarity determination module 114 can optionally determine different familiarity indications based on various additional data. For example, a route calculated between start and end points that are known user-saved favorites can be assumed to be a known route (e.g., a route passing through geographic areas with which the user is very familiar), or a route saved directly (e.g., in response to a user input) as a user favorite route can be assumed to be known (e.g., a route passing through geographic areas with which the user is very familiar). Additional data regarding familiarity with geographic areas can also be processed remotely by one or more computing devices accessed via a network (e.g., via a service in the cloud), and possibly as the aggregate of behavior observations from multiple devices. That data can be downloaded to any navigation device of the user for determining familiarity indications.

The familiarity determination module 114 can optionally determine different familiarity indications for different modes of transportation. Different modes of transportation can be supported, such as vehicle, walking, cycling, and so forth. Which mode the navigation device 100 is in at any different time can be determined in different manners, such as being specified by a user of the navigation device 100 or determined automatically. The transportation mode can be determined automatically in different manners, such as based on the speed at which the navigation device 100 is moving (e.g., as determined by the GNSS system 112). For example, if the navigation device 100 is moving at less than a first threshold speed (e.g., 4 miles per hour) then the mode is determined to be walking, if the navigation device 100 is moving at at least the first threshold speed but less than a second threshold speed (e.g., 20 miles per hour) then the mode is determined to be bicycling, and if the navigation device 100 is moving at the second threshold speed or faster then the mode is determined to be vehicle.

Thus, a user can have different familiarity indications for different modes of transportation in the same geographic area. For example, a user may have a familiarity indication of very familiar for a particular geographic area for the vehicle transportation mode, but a familiarity indication of not familiar at all for the walking mode.

Additionally or alternatively, the familiarity indications can be determined using different techniques. In one or more embodiments, the user of the navigation device 100 ignoring routes identified by the navigation system 106 is deemed to be the user being familiar with the geographic area in which the navigation device 100 is located at the times when the route is ignored. For example, the familiarity determination module 114 assumes that the user has a better or more desirable way to reach the destination and therefore ignores the route. For routes identified by the navigation system 106, if the user ignores one or more portions of the routes in a particular geographic area at least a threshold number of times or a least a threshold percentage of the time (e.g., at least 10 times, or at least 70% of the time), then the user is deemed to be familiar with the particular geographic area. This familiarity can be used to set or modify the familiarity indication. For example, if the user ignores one or more portions of the identified routes in a particular geographic area at least a threshold number of times or a least a threshold percentage of the time, then the familiarity indication for the particular geographic area can be set to very familiar, or alternatively can be modified to the next more familiar indication in the enumeration (e.g., if the familiarity indication is determined to be not familiar at all using other techniques discussed herein, then the familiarity indication can be modified to be slightly familiar).

In one or more embodiments, data other than the location of the navigation device 100 is used to determine the familiarity indications. For example, the navigation device 100 may include contact information (e.g., addresses) of friends, businesses, and so forth that the user travels to. This contact information can used to set or modify the familiarity indication. For example, if there are at least a threshold number (e.g., 10) of addresses in a particular geographic area then the familiarity indication for the geographic area can be set to very familiar, or alternatively can be modified to the next more familiar indication in the enumeration. Various other types information can analogously be used to set or modify the familiarity indication, such as a search history of the user (e.g., addresses of people or businesses that the user searched for).

Returning to FIG. 2, a route to a destination is identified (act 204). The route identified in act 204 passes though the geographic area determined in act 202. The destination refers to any geographic position, and can be identified in any of a variety of different manners. For example, the destination can be identified by a user input (e.g., a user input entering an address, selecting a stored or favorite address), by an indication from another component or device, and so forth. The route is identified from a current geographic position of the navigation device to the destination using any of a variety of public or proprietary techniques.

In one or more embodiments, the route is identified based on the familiarity of the user with various geographic areas. The route identification can give a preference to geographic areas that the user is more familiar with than geographic areas that the user is less familiar with. For example, if the route could take either one of two different roads, but the user is more familiar with (e.g., has a greater or larger familiarity indication for) one of the two different roads, that one of the two different roads is selected for inclusion in the route. By way of another example, if a portion of the route could pass through either one of two different neighborhoods, but the user is more familiar with (e.g., has a greater or larger familiarity indication for) one of the two different neighborhoods, the portion of the route that passes through that one of the two different neighborhoods is selected for inclusion in the route.

Navigation instructions regarding a route are generated based on the familiarity of the user with the geographic area (act 206). The navigation instructions (also referred to herein as simply instructions) refer to the information provided by the navigation system 106 along the route to the destination. The instructions can include directional guidance to direct a user to the destination, such as information regarding which roads to turn onto, which exits to take, a distance until a turn is to be made, directions to make turns, and so forth. For example, instructions may include “Turn right in 200 meters onto 1^{st} Avenue”, “Stay on highway for 45 miles”, “In 100 feet, turn left”, “Turn left now”, and so forth. The instructions can thus include warnings regarding upcoming turns or changes in direction of travel that are to be made. The instructions can also include warnings regarding changes in laws (e.g., an increase or decrease in the speed limit, a change in units of measure from kilometers per hour to miles per hour, etc.), warnings regarding traffic or construction, and so forth. These instructions vary with the familiarity of the user with the geographic area, so one user that is very familiar with the geographic area would get different instructions than a user that is not familiar at all with the geographic area. The instructions can vary based on the user familiarity with the geographic area in different manners, such as a delay in the start of instructions, a varied level of guidance in the instructions, an aggressiveness of route recalculation, combinations thereof, and so forth.

The determined instructions are presented by the navigation device (act 208). The instructions can be presented in different manners, such as displaying a map on a screen, displaying a list of instructions on a screen, playing back instructions audibly, combinations thereof, and so forth.

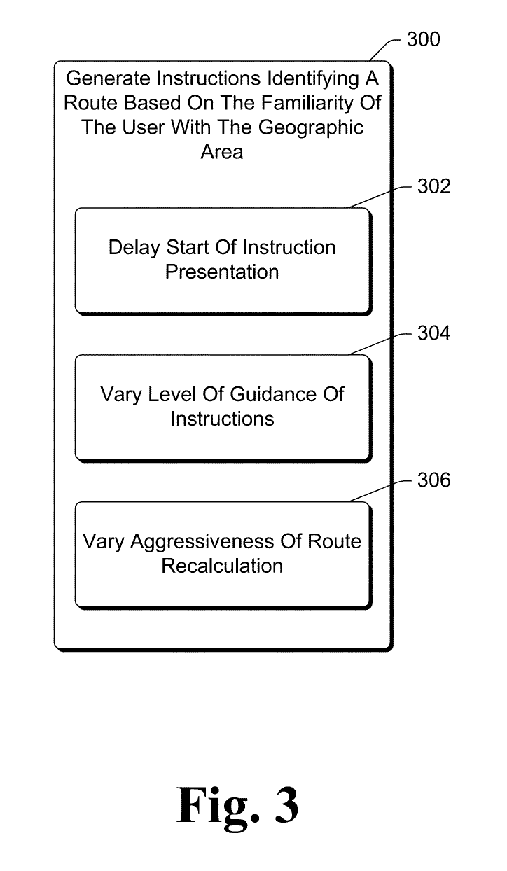

FIG. 3 is a flowchart illustrating an example process 300 for generating instructions regarding a route in accordance with one or more embodiments. Process 300 is carried out by a device, such as navigation device 100 of FIG. 1, and can be implemented in software, firmware, hardware, or combinations thereof. Process 300 can implement, for example, act 206 of FIG. 2. Process 300 is shown as a set of acts and is not limited to the order shown for performing the operations of the various acts. Process 300 is an example process for generating instructions regarding a route; additional discussions of generating instructions regarding a route are included herein with reference to different figures.

The process 300 includes one or more of delaying the start of instruction presentation (act 302), varying the level of guidance of instructions (act 304), and varying the aggressiveness of route recalculation (act 306). Although acts 302, 304, and 306 are illustrated as part of the process 300, it should be noted that the process 300 can alternatively include fewer than all of the acts 302, 304, and 306. For example, the process 300 may alternatively include acts 304 and 306, but not act 302.

Delaying the start of instruction presentation (act 302) includes waiting to start presenting the instructions along the route to the destination until the user is no longer in a familiar geographic area. The location along the route at which the instruction presentation is to begin can be determined in a variety of different manners. In one or more embodiments, a user input is received indicating the location along the route at which the instruction presentation is to begin. This user input can be a user input identifying a particular location on a map (e.g., by the user touching a location along the route), a user input selecting a particular instruction in a list of instructions (e.g., the list of instructions for the route being displayed), and so forth. This user input can also be an audible user input, such as a verbal command indicating to begin presenting instructions now (or after some amount of time elapses, optionally an amount of time specified by the user in the verbal command), a verbal command indicating to begin presenting instructions when some location is reached (e.g., a command to begin presenting instructions after the user is on a particular road).

Additionally or alternatively, the location along the route at which the instruction presentation is to begin can be determined automatically based on the familiarity of the user with one or more geographic areas along the route. For example, when the familiarity indication of the geographic area that the user is in as the user travels along the route drops below a threshold value (e.g., 0.5, or familiar), the instruction presentation begins.

As discussed above, different familiarity indications can be generated for different types of geographic areas. Which of the multiple different types of geographic areas are used to automatically determine the location along the route at which the instruction presentation is to begin can be determined in different manners. In one or more embodiments, one of the multiple different types of geographic areas is selected as the geographic area to use to automatically determine the location at which the instruction presentation is to begin based on a default setting (optionally specified by the user input) for different modes of transportation. For example, the type of geographic area may be neighborhood for the walking mode of transportation, but may be city for the vehicle mode of transportation.

Alternatively, one of the multiple different types of geographic areas is selected as the geographic area to use to automatically determine the location at which the instruction presentation is to begin based on the distance being traveled on the route (from the beginning of the route to the destination). Larger distances correspond to higher granularities than smaller distances. For example, if the distance is less than a first threshold amount (e.g., 0.25 miles) then the city block geographic area is selected, if the distance is at least the first threshold amount but less than a second threshold amount (e.g., 1 mile) then the neighborhood geographic area is selected, and so forth.

Alternatively, the lowest granularity geographic area may be initially selected. As the user travels along the route and moves out of the lowest granularity geographic area, the next higher granularity geographic area is selected. This process of selecting the next higher granularity geographic area each time the user moves out of the current granularity geographic area (or moves out of a lowest granularity geographic area into another geographic area with which the user is not familiar) continues until the user is no longer familiar with the selected geographic area (e.g., when the familiarity indication of the selected geographic area drops below a threshold value). For example, assume the route is from a location in one city to a location in a destination city, and that at the beginning of the route the familiarity indications of the city block geographic area and the neighborhood geographic area are both below the threshold value, but the familiarity indication of the city geographic area is not below the threshold value. The city block geographic area is initially selected, and as the user travels along the route, when the user moves out of the city block (or moves out of a city block and into another city block with a familiarity indication that is not below the threshold value) the neighborhood geographic area is selected. As the user continues to travel along the route, when the user moves out of the neighborhood geographic area the city geographic area is selected. The familiarity indication for the city geographic area is not below the threshold value, so the presenting of the instructions starts in response to the user moving out of the neighborhood geographic area.

While delaying starting presenting of instructions, the navigation system can delay displaying a map of the route, delay playing back audible instructions, or both. For example, the navigation system may continue to display a map of at least a portion of the route to the destination, and the user's current location on the route, but advantageously improve usability of the navigation system as well as increase energy savings by not playing back audible instructions. By way of another example, the navigation system may advantageously improve usability of the navigation system as well as increase energy savings by turning off the display and not playing back audible instructions. By way of yet another example, the navigation system may advantageously improve usability of the navigation system as well as increase energy savings by reducing a brightness of the display and not playing back audible instructions.

The varying the level of guidance of instructions (act 304) refers to automatically changing or selecting instructions to be presented to the user along the route based on the familiarity of the user with one or more geographic areas along the route. These instructions are typically instructions that are played back audibly, but can alternatively be instructions that are displayed.

As discussed above, different familiarity indications can be generated for different types of geographic areas. Which of the multiple different types of geographic areas are used to vary the level of guidance can be determined in different manners. In one or more embodiments, one of the multiple different types of geographic areas is selected as the geographic area to use to vary the level of guidance based on a default setting (optionally specified by the user input) for different modes of transportation. For example, the type of geographic area may be neighborhood for the walking mode of transportation, but may be city for the vehicle mode of transportation. Alternatively, one of the multiple different types of geographic areas can be selected as the geographic area to use to vary the level of guidance in different manners, such as based on user input requesting or identifying a particular type of geographic area, based on other rules or criteria, and so forth.

The level of guidance of instructions can be varied in a variety of different manners. In one or more embodiments, the level of guidance of instructions is varied by turning the instruction presentation on or off, which can include various actions such as not playing back instructions audibly, not displaying instructions, not displaying a map indicating a current location of the user or the route, combinations thereof, and so forth. Which actions are performed can vary based on the familiarity indication for the user for the geographic area. For example, audible playback and visual display can both be turned off if the familiarity indication for the geographic area is very familiar, audible playback can be turned off but the map can be visually displayed if the familiarity indication for the user for the geographic area is familiar, and instructions can be played back audibly and a map visually displayed if the familiarity indication for the user for the geographic area is slightly familiar or not familiar at all.

In one or more embodiments, the level of guidance of instructions is varied by selecting to present instructions (e.g., audibly playback instructions or display instructions) for all turns or only for major turns. A turn refers to a change in direction or streets, exiting or entering a freeway, and so forth. Which turns are major turns can be determined in a variety of different manners, such as being preconfigured in the navigation system, being based on the number of available lanes or width (e.g., number of lanes in a road, width or presence of a sidewalk) of the part of the route being turned onto (e.g., greater than 2 lanes is a major turn), based on a name or type of the part of the route being turned onto, and so forth. Whether instructions for all turns or only for major turns are presented can vary based on the familiarity indication for the user for the geographic area. For example, instructions can be presented for only major turns if the familiarity indication for the user for the geographic area is very familiar or familiar, and for all turns if the familiarity indication for the user for the geographic area is slightly familiar or not familiar at all.

In one or more embodiments, the level of guidance of instructions is varied by changing an amount of warning that is given regarding an upcoming turn. The amount of warning given can vary based on the familiarity indication for the user for the geographic area. More warning is given if the user is less familiar with the geographic area than if the user is more familiar with the geographic area. For example, a single warning of “turn right on First Avenue” can be audibly played back if the familiarity indication for the user for the geographic area is very familiar, a single warning of “turn right on First Avenue in 100 meters” can be audibly played back if the familiarity indication for the user for the geographic area is familiar, and as the user approaches the turn the warnings of “turn right on First Avenue in 500 meters”, “turn right on First Avenue in 300 meters”, “turn right on First Avenue in 100 meters”, “turn right now” can be played back audibly if the familiarity indication for the user for the geographic area is slightly familiar or not familiar at all.

In one or more embodiments, the level of guidance of instructions is varied by selecting whether to present warnings for changes in the law. Whether warnings for changes in the law are presented can vary based on the familiarity indication for the user for the geographic area. More warnings for changes in the law are given if the user is less familiar with the geographic area than if the user is more familiar with the geographic area. For example, if the user travels from one geographic area to another (e.g., one country to another) that uses a different unit of measure (e.g., displays speed limits in kilometers per hour rather than miles per hour), no warning of this change is presented if the familiarity indication for the user for the geographic area being traveled into is very familiar or familiar, but a warning of this change is presented if the familiarity indication for the user for the geographic area being traveled into is slightly familiar or not familiar at all. By way of another example, if the law changes (e.g., the speed limit increases or decreases), no warning of this change is presented if the familiarity indication for the user for the geographic area is very familiar or familiar, but a warning of this change is presented if the familiarity indication for the user for the geographic area is slightly familiar or not familiar at all.

In one or more embodiments, the level of guidance of instructions is varied by selecting whether to present the names of streets, roads, or other paths along the route. Whether to present such names can vary based on the familiarity indication for the user for the geographic area. For example, the name is presented if the familiarity indication for the user for the geographic area is very familiar or familiar (e.g., the instruction “turn right in 400 m onto Barbarossaplatz” may be given), the navigation system assuming the user understands the language in the geographic area. However, the name is not presented if the familiarity indication for the user for the geographic area is slightly familiar or not familiar at all (e.g., the instruction “turn right in 400 meters” may be given), the navigation system assuming the user does not understand the language in the geographic area.

In one or more embodiments, the level of guidance of instructions is varied by selecting whether to present minor instructions along the route. Minor instructions refer to instructions other than instructions to turn or enter/exit a road, such as instructions to change lanes (e.g., to prepare for an upcoming turn), instructions regarding slight bends where the user just follows the course of the road, instructions regarding continuing straight through a roundabout or traffic circle, information indicating the user has gone too far (e.g., “if you reach Fourth Street you've gone too far”), information indicating locations being passed (e.g., notifying the user he or she is passing a particular intersection, building, etc.), and so forth. Whether to present such minor instructions can vary based on the familiarity indication for the user for the geographic area. More minor instructions are given if the user is less familiar with the geographic area than if the user is more familiar with the geographic area. For example, the minor instructions are not presented if the familiarity indication for the user for the geographic area is very familiar or familiar, but the minor instructions are presented if the familiarity indication for the user for the geographic area is slightly familiar or not familiar.

In one or more embodiments, the level of guidance of instructions is varied by selecting whether to present warnings regarding potential delays (e.g., due to construction, an accident, heavy traffic, and so forth) along the route. Whether to present such warnings can vary based on the familiarity indication for the user for the geographic area. More warnings are given if the user is more familiar with the geographic area than if the user is less familiar with the geographic area. For example, the warning is presented if the familiarity indication for the user for the geographic area is very familiar or familiar, the navigation system assuming the user knows different routes through the geographic area and may choose a different route if there is a potential delay along another route. However, the warning is not presented if the familiarity indication for the user for the geographic area is slightly familiar or not familiar at all, the navigation system assuming the user does not know different routes through the geographic area and thus will be following the route provided by the navigation system (which can optionally be changed to avoid the potential delay).

Whether to present warnings regarding potential delays along the route can also vary based on the type of warning as well as whether the warning has previously been presented to the user. Warnings of ongoing potential delays may not be presented if the user is more familiar with the geographic area, but presented if the user is less familiar with the geographic area. For example, a warning about ongoing construction on a road is skipped (not presented) if the familiarity indication for the user for the geographic area is very familiar or familiar, the navigation system assuming the user knows about the ongoing construction and avoids telling the user about the construction every time the road is used. However, the warning is presented if the familiarity indication for the user for the geographic area is slightly familiar or not familiar at all, the navigation system assuming the user does not know about the construction.

Similarly, whether to present warnings regarding potential delays along the route can also vary based on whether the warning has previously been presented to the user. A record of warnings presented to a user over some time period (e.g., weeks or months) can be maintained by the navigation system, and the warning presented to the user only if the user has not already been presented with the warning at least a threshold number of times (e.g., one time). For example, a warning about ongoing construction on a road is skipped if the warning has already been given to the user, the navigation system assuming the user knows about the ongoing construction and avoids telling the user about the construction every time the road is used. However, the warning is presented if the warning has not already been given to the user, the navigation system assuming the user does not know about the construction

In one or more embodiments, the level of guidance of instructions is varied by simplifying the instructions. Simplifying the instructions refers to changing the instructions to specify a location along the route (on or near (e.g., within a threshold distance of) the route) rather than specifying turns, distances, and so forth in multiple instructions. The simplified instruction effectively combines multiple instructions into a single instruction that is different from, and identifies at least part of the route more generally, than any of the multiple instructions. For example, rather than a list of multiple instructions indicating to “turn right on Bel-Red Road, go 3 miles, turn left on Bellevue Way, turn right on Main St.”, the simplified instruction could be “drive to downtown Bellevue, near Main and Bellevue Way” or “drive to Bellevue Square shopping center”. It should be noted that simplifying the instructions refers to a change in what instruction(s) are presented to the user (e.g., a change in wording) as opposed to simply selecting which of the multiple instructions are to be presented or selecting to present only a portion of an instruction (e.g., selecting to present an instruction “turn right on First Avenue” rather than “turn right on First Avenue in 100 meters”).

The navigation system maintains or has access to a set of landmarks and their locations (e.g., geographic coordinates or other location identifiers). A landmark refers to a structure, geological formation, or other readily identifiable object. The set of landmarks can include global landmarks, personal landmarks, or a combination thereof. A global landmark refers to a landmark that most people familiar with an area would know, such as the Empire State Building, Bellevue Square shopping center, the Louvre Museum, King's Cross railway station, and so forth. A personal landmark refers to a landmark that the user is expected to know even if other people familiar with an area may not know the landmark. For example, personal landmarks can be a friend's house, a family member's house, a building where the user works, a store that the user shops at regularly, a theater that the user has been to at least a threshold number of times, and so forth.

Whether instructions are simplified can vary based on the familiarity indication for the user for the geographic area as well as whether a route passes near (e.g., within a threshold distance of, such as 1 mile for the vehicle mode of transportation, or 0.1 miles for the walking mode of transportation) a landmark in the set of landmarks. For example, in situations in which a route passes near a landmark in the set of landmarks and the familiarity indication for the user for the geographic area that includes the landmark is very familiar or familiar, the instructions are simplified by being changed to route the user to the landmark. E.g., assume that the set of landmarks for a user includes King's Cross railway station, that the familiarity indication for the user for the geographic area that includes King's Cross railway station is very familiar or familiar, and that a route to a destination passes a location near King's Cross railway station but includes ten different instructions to take the user from his or her current location to the location near King's Cross railway station. Those ten different instructions can be simplified and replaced with a single instruction of, for example, “go to King's Cross railway station”. Once the user reaches the location near King's Cross railway station, presentation of the regular (non-simplified) instructions along the route can resume. However, in situations in which a route passes near a landmark in the set of landmarks and the familiarity indication for the user for the geographic area that includes the landmark is slightly familiar or not familiar at all, the instructions are not simplified (e.g., the ten different instructions to take the user from his or her current location to the location near King's Cross railway station are presented to the user if the familiarity indication for the user for the geographic area that includes King's Cross railway station is slightly familiar or not familiar at all).

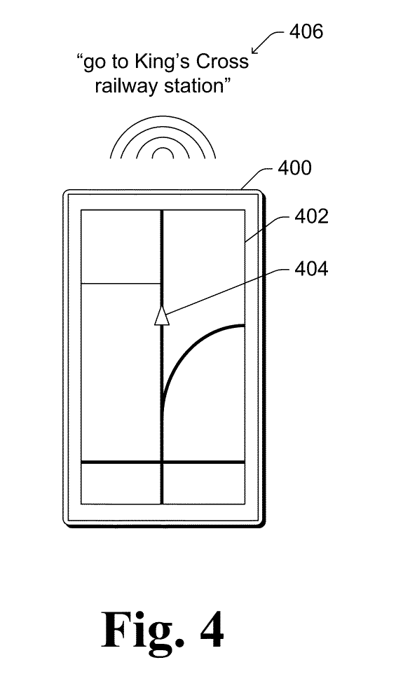

FIG. 4 illustrates an example user interface presenting simplified instructions in accordance with one or more embodiments. FIG. 4 includes a navigation device 400, which can be a navigation device 100 of FIG. 1. A map 402 is displayed by the navigation device 400, including various streets and an arrow 404 indicating a current location of the user. An audible instruction 406 is played back to the user, instructing the user to “go to King's Cross railway station”. Thus, as the user progresses towards King's Cross railway station using a route that the user is presumably familiar with, additional instructions regarding turns to make, lanes to be in, and so forth are not played back to the user. The usability of the navigation device 400 is advantageously improved because the user is not bothered with instructions on how to get to a location (King's Cross railway station) that he or she already knows how to get to.

Returning to FIG. 3, it should be noted that, if the route does not pass near a particular landmark in the set of landmarks, but passes within another threshold distance of the particular landmark (e.g., within 3 miles for the vehicle mode of transportation), the route can be changed so that it does pass near the particular landmark if doing so would allow the navigation instructions to be simplified. For example, if the user were very familiar or familiar with a geographic area that includes a location near the particular landmark, the familiarity-based route identification module 116 can change the route so that the route passes through the location near the particular landmark, allowing the instructions to be simplified.

It should be noted that the simplifying of instructions can also be performed without using (in the absence of) a set of landmarks. A location in a geographic area that is known to the user (e.g., having a familiarity indication of very familiar or familiar) and that is near (e.g., within a threshold distance of) the route to the destination can be selected, and the instructions simplified to direct the user to that location. The location can be, for example, an intersection of major roads or other paths, a single particular major road or other path, and so forth. The major roads or other paths can be determined in a variety of different manners, such as being preconfigured in the navigation system, being based on number of lanes in the road (e.g., greater than 2 lanes is a major road), based on a name or type of the road or other path, and so forth. If multiple locations (e.g., multiple intersections) would be known to the user, one of the multiple locations can be selected. For example, the one of the multiple locations that is near the route to the destination and in a geographic area known to the user but is furthest from a current location of the user can be selected.

By way of example, assume the user is traveling to a destination along a route that passes through a location (e.g., the intersection of Main Street and Bellevue Way) in Bellevue, and that the route includes eight different instructions to take the user from his or her current location to the intersection of Main Street and Bellevue Way in Bellevue. Those eight different instructions can be simplified and replaced with a single instruction of, for example, “go to Bellevue near Main Street and Bellevue Way”. Once the user reaches the intersection of Main Street and Bellevue Way in Bellevue, presentation of the regular (non-simplified) instructions along the route can resume.

By way of another example, assume the user is traveling to a destination along a route that includes traveling on a major highway (e.g., Interstate 75), and that the route includes seven different instructions to take the user from his or her current location to the entrance ramp of the major highway. Those seven different instructions can be simplified and replaced with a single instruction of, for example, “get on Interstate 75 heading North”. Once the user is on Interstate 75, presentation of the regular (non-simplified) instructions along the route can resume.

The varying the aggressiveness of route recalculation (act 306) refers to how quickly or how persistently the navigation system provides instructions regarding recalculating a route after the user has strayed from the route. Straying from the route refers to the user taking roads, turns, other paths, and so forth that are not part of the route. As discussed above, different familiarity indications can be generated for different types of geographic areas. Which of the multiple different types of geographic areas are used to vary the aggressiveness of route recalculation can be determined in different manners. In one or more embodiments, one of the multiple different types of geographic areas is selected as the geographic area to use to vary the aggressiveness of route recalculation based on a default setting (optionally specified by the user input) for different modes of transportation. For example, the type of geographic area may be neighborhood for the walking mode of transportation, but may be city for the vehicle mode of transportation. Alternatively, one of the multiple different types of geographic areas can be selected as the geographic area to use to vary the aggressiveness of route recalculation in different manners, such as based on user input requesting or identifying a particular type of geographic area, based on other rules or criteria, and so forth.

The aggressiveness of route recalculation can be varied in a variety of different manners. The aggressiveness of route recalculation can vary can vary based on the familiarity indication for the user for the geographic area. For example, if the familiarity indication for the user for the geographic area is slightly familiar or not familiar at all, then route recalculation is performed and instructions based on the recalculated route are provided to the user. However, if the familiarity indication for the user for the geographic area is very familiar or familiar, then no route recalculation may be performed or the route recalculation may be delayed (e.g., delayed a threshold amount of time which can vary based on the mode of transportation, the distance to the destination, and so forth). E.g., the navigation system may continue to monitor the current route the user is taking to see whether the current route converges with the previously calculated route (in which case no route recalculation need be performed), or the navigation system could recalculate the route to identify a new route that is consistent with the current route the user is taking.

The techniques discussed herein support various different usage scenarios. For example, consider a user driving from a cul-de-sac in a New York City suburb (where she lives) to a hotel in Montreal (where she has never been). As the user leaves her own neighborhood, the navigation system is completely silent because she is extremely familiar with her cul-de-sac and how to get out of her own neighborhood. As she heads toward the main street, the navigation system tells her to get on the New York State Thruway northbound, because the system knows that she is familiar with the route to the highway. As she heads into upstate New York, a geographic area she has been to a few times, the navigation system gives her more detailed information about which exit to take to stay on I-87 toward Montreal. When she crosses the border into Canada, a country she is not familiar with, the navigation system provides more proactive speed limit and directional information since the speed limits are now measured in kilometers and the signs are now written in French. When she enters Montreal, the guidance system gives extremely detailed directions and multiple advanced warnings for turns, because the user has never been anywhere near the city before.

In the discussions herein, reference is made to instructions being presented to the user while the user travels along a route. It should be noted that in one or more embodiments, the navigation instructions can similarly be presented at various other times, such as prior to the user beginning travel along the route (e.g., printed out or displayed for the user to review), without the user traveling along the route (e.g., for the user to review regardless of whether he or she travels along the route), and so forth. For example, automatically changing or selecting instructions to be presented to the user as performed when varying the level of guidance of instructions discussed above can be performed for instructions along the route regardless of whether the user is traveling along the route at the time of presentation. By way of another example, delaying the start of instruction presentation as discussed above can be performed by printing, displaying, playing back audibly, or otherwise presenting the instructions beginning at a location along the route at which instruction presentation is to begin as discussed above regardless of whether the user is traveling along the route at the time of presentation.

Returning to FIG. 1, in one more embodiments, the familiarity determination module 114 records various data indicating the position of the navigation device 100 at various times to determine the familiarity of the user with different geographic areas, and the recording of data indicating the position of the device 100 is performed after receiving user consent to do so. This user consent can be an opt-in consent, where the user takes an affirmative action to request that the position data be recorded before the navigation device 100 performs any recording of data for the device 100. Alternatively, this user consent can be an opt-out consent, where the user takes an affirmative action to request that the position data not be recorded; if the user does not choose to opt out of this recording of the position data, then it is an implied consent by the user to record the position data.

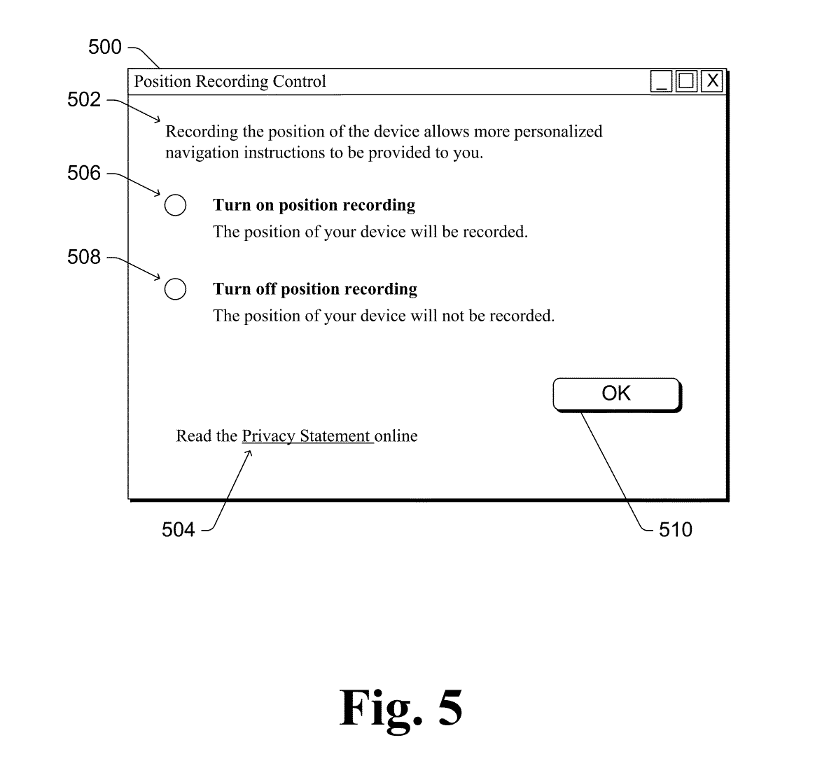

FIG. 5 illustrates an example user interface that can be displayed to a user of a device to allow the user to select whether position data for that device will be recorded in accordance with one or more embodiments. A position recording control window 500 is displayed including a description 502 explaining to the user why the position of the device is being recorded. A link 504 to a privacy statement is also displayed. If the user selects link 504, a privacy statement is displayed, explaining to the user how the recorded position data is kept confidential and/or how no association between the position and the device (as well as the user of the device) is maintained.

Additionally, the user is able to select a radio button 506 to opt-in to the position recording, or a radio button 508 to opt-out of the position recording. Once a radio button 506 or 508 is selected, the user can select an “OK” button 510 to have the selection saved. It is to be appreciated that radio buttons and an “OK” button are only examples of user interfaces that can be presented to a user to opt-in or opt-out of the position recording, and that a variety of other conventional user interface techniques can alternatively be used. The device then proceeds to record or not record the device position in accordance with the user's selection.

Although particular functionality is discussed herein with reference to particular modules, it should be noted that the functionality of individual modules discussed herein can be separated into multiple modules, and/or at least some functionality of multiple modules can be combined into a single module. Additionally, a particular module discussed herein as performing an action includes that particular module itself performing the action, or alternatively that particular module invoking or otherwise accessing another component or module that performs the action (or performs the action in conjunction with that particular module). Thus, a particular module performing an action includes that particular module itself performing the action and/or another module invoked or otherwise accessed by that particular module performing the action.

In the discussions herein, various different embodiments are described. It is to be appreciated and understood that each embodiment described herein can be used on its own or in connection with one or more other embodiments described herein.

Further aspects of the techniques discussed herein relate to one or more of the following embodiments.

A method implemented in a navigation device comprises determining familiarity of a user of the navigation device with a geographic area; identifying a route to a destination, the route passing through at least part of the geographic area; generating navigation instructions regarding the route based on the familiarity of the user with the geographic area, the generating including changing multiple instructions regarding part of the route to a simplified instruction that specifies a location along the route; and presenting the generated instructions, the presenting including presenting the simplified instruction rather than the multiple instructions.

In the above described method, the determining the familiarity of the user with the geographic area comprising determining the familiarity of the user with the geographic area based at least in part on how much time the user is in the geographic area.

In any one or more of the above described methods, the determining the familiarity of the user with the geographic area comprising determining the familiarity of the user with the geographic area for each of multiple different transportation modes including a walking mode and a vehicle mode.

In any one or more of the above described methods, the determining the familiarity of the user with the geographic area comprising determining the familiarity of the user with each of multiple different types of geographic areas, each different type of geographic area being a different granularity of geographic area.

In any one or more of the above described methods, the multiple different types of geographic areas including a city block type of geographic area, a neighborhood type of geographic area, and a city type of geographic area.

In any one or more of the above described methods, the generating instructions regarding the route further including delaying starting of presentation of the instructions based on the familiarity of the user with the geographic area.

In any one or more of the above described methods, the generating instructions regarding the route further including varying an aggressiveness of route recalculation based on the familiarity of the user with the geographic area.

In any one or more of the above described methods, the generating instructions regarding the route further including selecting whether to present warnings regarding potential delays along the route.

In any one or more of the above described methods, the location along the route comprising a landmark.

In any one or more of the above described methods, the location along the route comprising an intersection of multiple roads.

In any one or more of the above described methods, the location along the route comprising a particular road along the route.

A navigation device comprises a global navigation satellite system, implemented at least in part in hardware, configured to determine a position of the navigation device; a familiarity determination module configured to determine a familiarity of a user of the navigation device with a geographic area; and a familiarity-based route identification module configured to identify a route from the position of the navigation device to a destination, the route passing through at least part of the geographic area, generate navigation instructions regarding the route based on the familiarity of the user with the geographic area, including varying an aggressiveness of route recalculation based on the familiarity of the user with the geographic area, and present the generated instructions.

In the above described navigation device, the determination of the familiarity of the user with the geographic area comprising determination of the familiarity of the user with the geographic area based at least in part on how much time the user is in the geographic area.

In any one or more of the above described navigation devices, the determination of the familiarity of the user with the geographic area comprising determination of the familiarity of the user with the geographic area for each of multiple different transportation modes including a walking mode and a vehicle mode.

In any one or more of the above described navigation devices, the determination of the familiarity of the user with the geographic area comprising determination of the familiarity of the user with each of multiple different types of geographic areas, each different type of geographic area being a different granularity of geographic area.

In any one or more of the above described navigation devices, the multiple different types of geographic areas including a city block type of geographic area, a neighborhood type of geographic area, and a city type of geographic area.

In any one or more of the above described navigation devices, the generation of instructions regarding the route further including delaying starting of presentation of the instructions based on the familiarity of the user with the geographic area.

In any one or more of the above described navigation devices, the generation of instructions regarding the route further including selecting whether to present warnings regarding potential delays along the route.

In any one or more of the above described navigation devices, the generation of instructions regarding the route further including varying a level of guidance of the by simplifying one or more of the instructions.

A method comprises, or a computer-readable storage medium having stored thereon multiple instructions that, responsive to execution by one or more processors of a computing device, cause the one or more processors to perform acts that comprise: determining, for each of multiple different transportation modes including a walking mode and a vehicle mode, a familiarity of a user of the computing device with a geographic area; identifying a route to a destination, the route passing through at least part of the geographic area; generating navigation instructions regarding the route based on the familiarity of the user with the geographic area for a current transportation mode of the computing device, the generating including changing multiple instructions regarding part of the route to a simplified instruction that specifies a location along the route, and further including varying an aggressiveness of route recalculation based on the familiarity of the user with the geographic area for the current transportation mode of the computing device; and presenting the generated instructions.

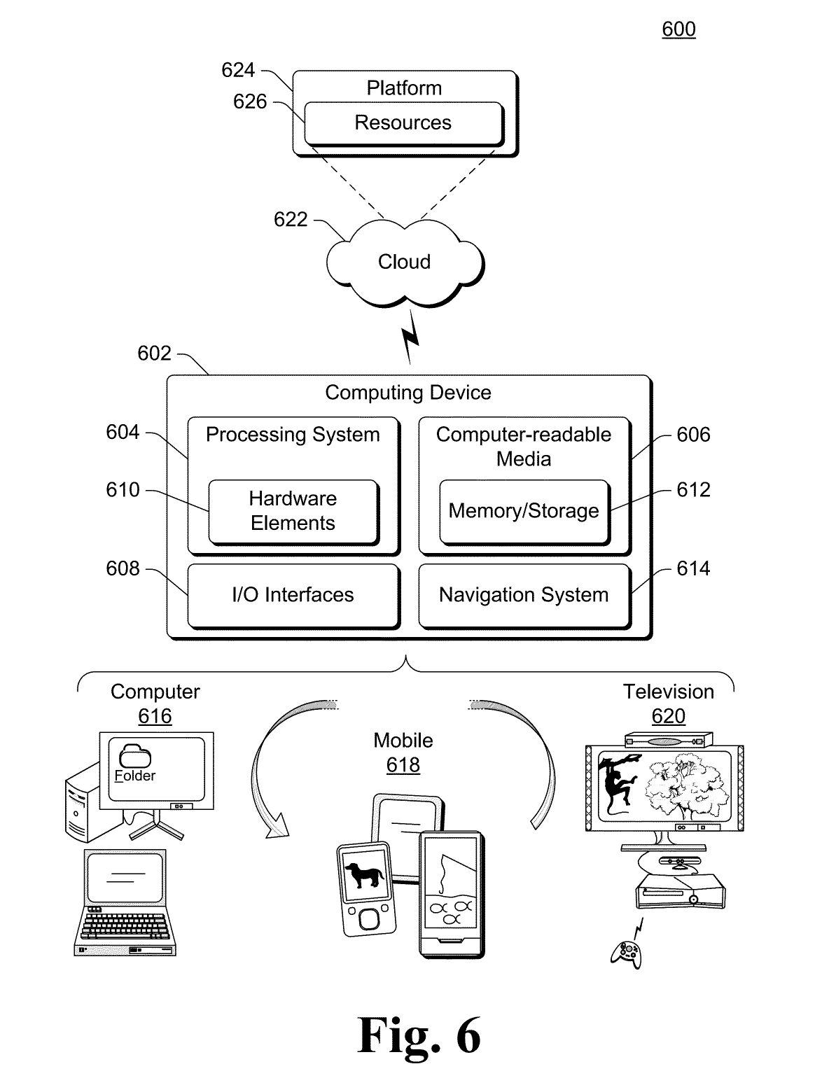

FIG. 6 illustrates an example system generally at 600 that includes an example computing device 602 that is representative of one or more systems and/or devices that may implement the various techniques described herein. The computing device 602 may be, for example, a server of a service provider, a device associated with a client (e.g., a client device), an on-chip system, and/or any other suitable computing device or computing system. The computing device 602 can be, for example, a navigation device 100 of FIG. 1.

The example computing device 602 as illustrated includes a processing system 604, one or more computer-readable media 606, and one or more I/O Interfaces 608 that are communicatively coupled, one to another. Although not shown, the computing device 602 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 604 is representative of functionality to perform one or more operations using hardware. Accordingly, the processing system 604 is illustrated as including hardware elements 610 that may be configured as processors, functional blocks, and so forth. This may include implementation in hardware as an application specific integrated circuit or other logic device formed using one or more semiconductors. The hardware elements 610 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable media 606 is illustrated as including memory/storage 612. The memory/storage 612 represents memory/storage capacity associated with one or more computer-readable media. The memory/storage 612 may include volatile media (such as random access memory (RAM)) and/or nonvolatile media (such as read only memory (ROM), Flash memory, optical disks, magnetic disks, and so forth). The memory/storage 612 may include fixed media (e.g., RAM, ROM, a fixed hard drive, and so on) as well as removable media (e.g., Flash memory, a removable hard drive, an optical disc, and so forth). The computer-readable media 606 may be configured in a variety of other ways as further described below.

Input/output interface(s) 608 are representative of functionality to allow a user to enter commands and information to computing device 602, and also allow information to be presented to the user and/or other components or devices using various input/output devices. Examples of input devices include a keyboard, a cursor control device (e.g., a mouse), a microphone (e.g., for voice inputs), a scanner, touch functionality (e.g., capacitive or other sensors that are configured to detect physical touch), a camera (e.g., which may employ visible or non-visible wavelengths such as infrared frequencies to detect movement that does not involve touch as gestures), and so forth. Examples of output devices include a display device (e.g., a monitor or projector), speakers, a printer, a network card, tactile-response device, and so forth. Thus, the computing device 602 may be configured in a variety of ways as further described below to support user interaction.

Computing device 602 also includes a navigation system 614. Navigation system 614 provides various navigation and guidance functionality as discussed herein. Navigation system 614 can be, for example, navigation system 106 of FIG. 1.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of computing platforms having a variety of processors.

An implementation of the described modules and techniques may be stored on or transmitted across some form of computer-readable media. The computer-readable media may include a variety of media that may be accessed by the computing device 602. By way of example, and not limitation, computer-readable media may include “computer-readable storage media” and “computer-readable signal media.”

“Computer-readable storage media” refers to media and/or devices that enable persistent storage of information and/or storage that is tangible, in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” refers to a signal-bearing medium that is configured to transmit instructions to the hardware of the computing device 602, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 610 and computer-readable media 606 are representative of instructions, modules, programmable device logic and/or fixed device logic implemented in a hardware form that may be employed in some embodiments to implement at least some aspects of the techniques described herein. Hardware elements may include components of an integrated circuit or on-chip system, an application-specific integrated circuit (ASIC), a field-programmable gate array (FPGA), a complex programmable logic device (CPLD), and other implementations in silicon or other hardware devices. In this context, a hardware element may operate as a processing device that performs program tasks defined by instructions, modules, and/or logic embodied by the hardware element as well as a hardware device utilized to store instructions for execution, e.g., the computer-readable storage media described previously.

Combinations of the foregoing may also be employed to implement various techniques and modules described herein. Accordingly, software, hardware, or program modules and other program modules may be implemented as one or more instructions and/or logic embodied on some form of computer-readable storage media and/or by one or more hardware elements 610. The computing device 602 may be configured to implement particular instructions and/or functions corresponding to the software and/or hardware modules. Accordingly, implementation of modules as a module that is executable by the computing device 602 as software may be achieved at least partially in hardware, e.g., through use of computer-readable storage media and/or hardware elements 610 of the processing system. The instructions and/or functions may be executable/operable by one or more articles of manufacture (for example, one or more computing devices 602 and/or processing systems 604) to implement techniques, modules, and examples described herein.

As further illustrated in FIG. 6, the example system 600 enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 600, multiple devices are interconnected through a central computing device. The central computing device may be local to the multiple devices or may be located remotely from the multiple devices. In one or more embodiments, the central computing device may be a cloud of one or more server computers that are connected to the multiple devices through a network, the Internet, or other data communication link.

In one or more embodiments, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one or more embodiments, a class of target devices is created and experiences are tailored to the generic class of devices. A class of devices may be defined by physical features, types of usage, or other common characteristics of the devices.

In various implementations, the computing device 602 may assume a variety of different configurations, such as for computer 616, mobile 618, and television 620 uses. Each of these configurations includes devices that may have generally different constructs and capabilities, and thus the computing device 602 may be configured according to one or more of the different device classes. For instance, the computing device 602 may be implemented as the computer 616 class of a device that includes a personal computer, desktop computer, a multi-screen computer, laptop computer, netbook, and so on.

The computing device 602 may also be implemented as the mobile 618 class of device that includes mobile devices, such as a mobile phone, portable music player, portable gaming device, a tablet computer, a multi-screen computer, and so on. The computing device 602 may also be implemented as the television 620 class of device that includes devices having or connected to generally larger screens in casual viewing environments. These devices include televisions, set-top boxes, gaming consoles, and so on.

The techniques described herein may be supported by these various configurations of the computing device 602 and are not limited to the specific examples of the techniques described herein. This functionality may also be implemented all or in part through use of a distributed system, such as over a “cloud” 622 via a platform 624 as described below.

The cloud 622 includes and/or is representative of a platform 624 for resources 626. The platform 624 abstracts underlying functionality of hardware (e.g., servers) and software resources of the cloud 622. The resources 626 may include applications and/or data that can be utilized while computer processing is executed on servers that are remote from the computing device 602. Resources 626 can also include services provided over the Internet and/or through a subscriber network, such as a cellular or Wi-Fi network.

The platform 624 may abstract resources and functions to connect the computing device 602 with other computing devices. The platform 624 may also serve to abstract scaling of resources to provide a corresponding level of scale to encountered demand for the resources 626 that are implemented via the platform 624. Accordingly, in an interconnected device embodiment, implementation of functionality described herein may be distributed throughout the system 600. For example, the functionality may be implemented in part on the computing device 602 as well as via the platform 624 that abstracts the functionality of the cloud 622.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method implemented in a navigation device, the method comprising:
determining familiarity of a user of the navigation device with a geographic area;
identifying a route to a destination, the route passing through at least part of the geographic area;
generating navigation instructions regarding the route based on the familiarity of the user with the geographic area, the generating including changing multiple instructions regarding part of the route to a simplified instruction that specifies a location along the route; and
presenting the generated instructions, the presenting including presenting the simplified instruction rather than the multiple instructions.

2. A method as recited in claim 1, the determining the familiarity of the user with the geographic area comprising determining the familiarity of the user with the geographic area based at least in part on how much time the user is in the geographic area.

3. A method as recited in claim 1, the determining the familiarity of the user with the geographic area comprising determining the familiarity of the user with the geographic area for each of multiple different transportation modes including a walking mode and a vehicle mode.

4. A method as recited in claim 1, the determining the familiarity of the user with the geographic area comprising determining the familiarity of the user with each of multiple different types of geographic areas, each different type of geographic area being a different granularity of geographic area.

5. A method as recited in claim 4, the multiple different types of geographic areas including a city block type of geographic area, a neighborhood type of geographic area, and a city type of geographic area.

6. A method as recited in claim 1, the generating instructions regarding the route further including delaying starting of presentation of the instructions based on the familiarity of the user with the geographic area.

7. A method as recited in claim 1, the generating instructions regarding the route further including varying an aggressiveness of route recalculation based on the familiarity of the user with the geographic area.

8. A method as recited in claim 1, the generating instructions regarding the route further including selecting whether to present warnings regarding potential delays along the route.

9. A method as recited in claim 1, the location along the route comprising a landmark.

10. A method as recited in claim 1, the location along the route comprising an intersection of multiple roads.

11. A method as recited in claim 1, the location along the route comprising a particular road along the route.

12. A navigation device comprising:
a global navigation satellite system, implemented at least in part in hardware, configured to determine a position of the navigation device;
a familiarity determination module configured to determine a familiarity of a user of the navigation device with a geographic area; and
a familiarity-based route identification module configured to
identify a route from the position of the navigation device to a destination, the route passing through at least part of the geographic area,
generate navigation instructions regarding the route based on the familiarity of the user with the geographic area, including varying an aggressiveness of route recalculation based on the familiarity of the user with the geographic area, and
present the generated instructions.

13. A navigation device as recited in claim 12, the determination of the familiarity of the user with the geographic area comprising determination of the familiarity of the user with the geographic area based at least in part on how much time the user is in the geographic area.

14. A navigation device as recited in claim 12, the determination of the familiarity of the user with the geographic area comprising determination of the familiarity of the user with the geographic area for each of multiple different transportation modes including a walking mode and a vehicle mode.

15. A navigation device as recited in claim 12, the determination of the familiarity of the user with the geographic area comprising determination of the familiarity of the user with each of multiple different types of geographic areas, each different type of geographic area being a different granularity of geographic area

16. A navigation device as recited in claim 15, the multiple different types of geographic areas including a city block type of geographic area, a neighborhood type of geographic area, and a city type of geographic area.

17. A navigation device as recited in claim 12, the generation of instructions regarding the route further including delaying starting of presentation of the instructions based on the familiarity of the user with the geographic area.

18. A navigation device as recited in claim 12, the generation of instructions regarding the route further including selecting whether to present warnings regarding potential delays along the route.

19. A navigation device as recited in claim 12, the generation of instructions regarding the route further including varying a level of guidance of the instructions by simplifying one or more of the instructions.

20. A computer-readable storage medium having stored thereon multiple instructions that, responsive to execution by one or more processors of a computing device, cause the one or more processors to perform acts comprising:
determining, for each of multiple different transportation modes including a walking mode and a vehicle mode, a familiarity of a user of the computing device with a geographic area;
identifying a route to a destination, the route passing through at least part of the geographic area;
generating navigation instructions regarding the route based on the familiarity of the user with the geographic area for a current transportation mode of the computing device, the generating including changing multiple instructions regarding part of the route to a simplified instruction that specifies a location along the route, and further including varying an aggressiveness of route recalculation based on the familiarity of the user with the geographic area for the current transportation mode of the computing device; and
presenting the generated instructions.
